(19) United States
(12) Patent Application Publication
(10) Pub. No.: US 2026/0323328 A1
(43) Pub. Date: Oct. 15, 2026

(54) METHOD TO ENABLE USER EQUIPMENT (UE) FEATURES BASED ON INTEROPERABILITY DEVICE TESTING (IODT) STATUS

(71) Applicant: QUALCOMM Incorporated, San Diego, CA (US)

(72) Inventors: Mona AGRAWAL, San Diego, CA (US); Liangchi HSU, San Diego, CA (US); Daniel AMERGA, San Diego, CA (US); Girish KHANDELWAL, San Diego, CA (US); Ozcan OZTURK, San Diego, CA (US); Gavin Bernard HORN, La Jolla, CA (US); Masato KITAZOE, Hachiouji-shi (JP); Marc AZAR, La Jolla, CA (US); Vinesh Kisan KAVISKAR, San Diego, CA (US); Sindhu SATYAN, San Diego, CA (US); Sarath Kumar PUJARI, Hyderabad (IN)

(21) Appl. No.: 19/178,768

(22) Filed: Apr. 14, 2025

(51) Int. Cl. H04W 24/08; H04W 8/22; H04W 76/20; H04W 76/40

(52) U.S. Cl. CPC H04W 24/08; H04W 8/22; H04W 76/20; H04W 76/40

(57) ABSTRACT

Techniques described herein may allow a user equipment (UE) to inform a network device about its ability to support a wireless feature. Additionally, the UE must clarify whether the wireless feature is supported with specific vendors of gNodeBs (gNBs). For example, the UE may provide details to the network device indicating which gNB vendors it has successfully tested the wireless feature. If the wireless feature has been tested with a specific gNB vendor equipment (e.g., a gNB from vendor A), the gNB from the vendor A may configure the UE to use the wireless feature. However, if the wireless feature has not been tested with a specific gNB vendor equipment (e.g., a gNB from vendor B), the gNB from the vendor B may not configure the UE to use the wireless feature.

### BACKGROUND

### Field of the Disclosure

Aspects of the present disclosure relate to wireless communications, and more particularly, to techniques for managing enabling of wireless features on a user equipment (UE).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes transmitting capability information indicating at least one of: one or more features supported by the UE or a list of one or more network entity vendors with which the one or more features have been tested via one or more tests; and receiving a configuration for features based on the capability information.

Another aspect provides a method for wireless communications at a network entity. The method includes receiving capability information of a UE indicating at least one of: one or more features supported by the UE or a list of one or more network entity vendors with which the one or more features have been tested via one or more tests; and transmitting a configuration for features based on the capability information of the UE.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network, in accordance with certain aspects of the present disclosure.

FIG. 2 depicts an example disaggregated base station (BS) architecture, in accordance with certain aspects of the present disclosure.

FIG. 3 depicts aspects of an example BS and an example user equipment (UE), in accordance with certain aspects of the present disclosure.

FIG. 4A, FIG. 4B, FIG. 4C, and FIG. 4D depict various example aspects of data structures for a wireless communications network, in accordance with certain aspects of the present disclosure.

FIG. 5 depicts example wireless communications system, in accordance with certain aspects of the present disclosure.

FIG. 6 depicts example flow diagram illustrating communication between multiple devices, in accordance with certain aspects of the present disclosure.

FIG. 7 depicts another example flow diagram illustrating communication between multiple devices, in accordance with certain aspects of the present disclosure.

FIG. 8 depicts a call flow diagram illustrating communication between a UE and a gNodeB (gNB) for managing enabling of wireless features on a UE, in accordance with certain aspects of the present disclosure.

FIG. 9 depicts another example wireless communications system, in accordance with certain aspects of the present disclosure.

FIG. 10 depicts another example flow diagram illustrating communication between multiple devices, in accordance with certain aspects of the present disclosure.

FIG. 11A and FIG. 11B depict another example flow diagram illustrating communication between multiple devices, in accordance with certain aspects of the present disclosure.

FIG. 12 depicts a method for wireless communications at a UE for managing enabling of wireless features on a UE, in accordance with certain aspects of the present disclosure.

FIG. 13 depicts a method for wireless communications at a network entity for managing enabling of wireless features on a UE, in accordance with certain aspects of the present disclosure.

FIG. 14 and FIG. 15 depict example wireless nodes configured for managing enabling of wireless features on a UE, in accordance with certain aspects of the present disclosure.

### DETAILED DESCRIPTION

In wireless systems, development of new wireless features (e.g., 6th generation (6G) services) often requires coordination between multiple stakeholders such as user equipment (UE) vendors (e.g., smartphone manufacturers, modem chipset manufacturers or device makers), base stations or gNodeB (gNB) vendors, and operators (e.g., telecom service providers) to ensure that UEs can fully support the new wireless features across a range of different network environments.

For example, to ensure that a UE functions optimally in the real world and supports all new wireless features, the UE has to be tested against all gNB vendors to confirm that the UE can operate the new wireless features across gNBs from most or all gNB vendors. For instance, interoperability and thorough testing with all gNB vendors is vital to maintaining a high-quality user experience and ensuring that the UE performs as expected in real-world conditions where the UE may establish a connection with a gNB from any gNB vendor.

In some cases, a new wireless feature supported by the UE might only be tested with gNBs from some specific gNB vendors and not from all gNB vendors that the UE might connect to. In such cases, even though the UE may show that it supports the new wireless feature, this does not guarantee that the new wireless feature will work as expected with any gNB, especially if the UE connects to the gNB from a gNB vendor that hasn't been part of the testing process. This means that, in the absence of full testing across most or all gNB vendors, the new wireless feature could fail or not function properly when the UE interacts with the gNB from the gNB vendor that hasn't been tested for compatibility with the new wireless feature.

Techniques described herein may allow a UE to inform a network device about its ability to support a particular wireless feature. Additionally, the UE may clarify whether the particular wireless feature is supported exclusively with specific vendors of gNBs. For example, the UE may provide details to the network device indicating which gNB vendors it has successfully tested the particular wireless feature with through an interoperability device testing (IODT) process.

If the particular wireless feature has been tested with a specific gNB vendor equipment (e.g., a gNB from a vendor A), the gNB from the vendor A may configure the UE to use that particular wireless feature. However, if the particular wireless feature has not been tested with a specific gNB vendor equipment (e.g., a gNB from a vendor B), the gNB from the vendor B may not configure the UE to use that particular wireless feature.

As a result, the techniques proposed herein may help ensure compatibility and minimize potential issues with the particular wireless feature performance on a network.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

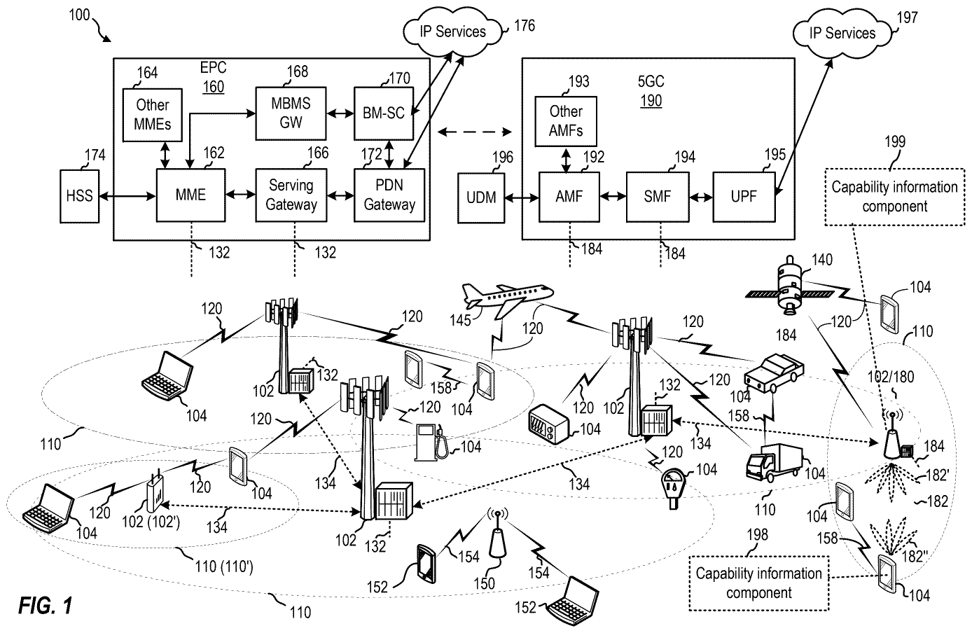

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others. UEs 104 may operate as relay devices.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

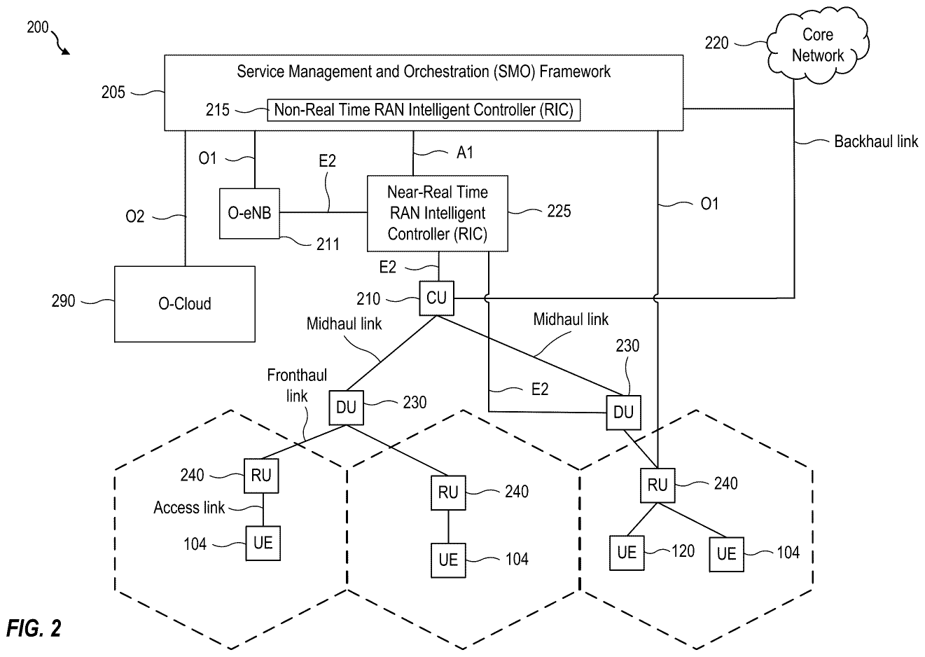

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 130) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

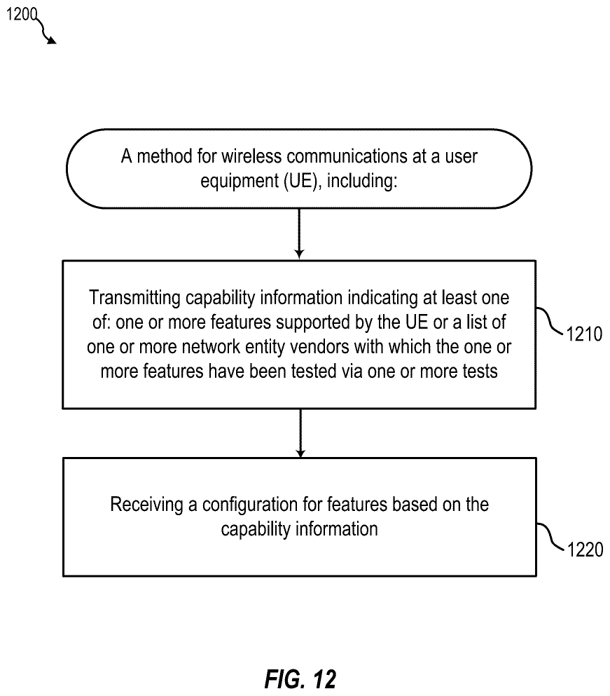

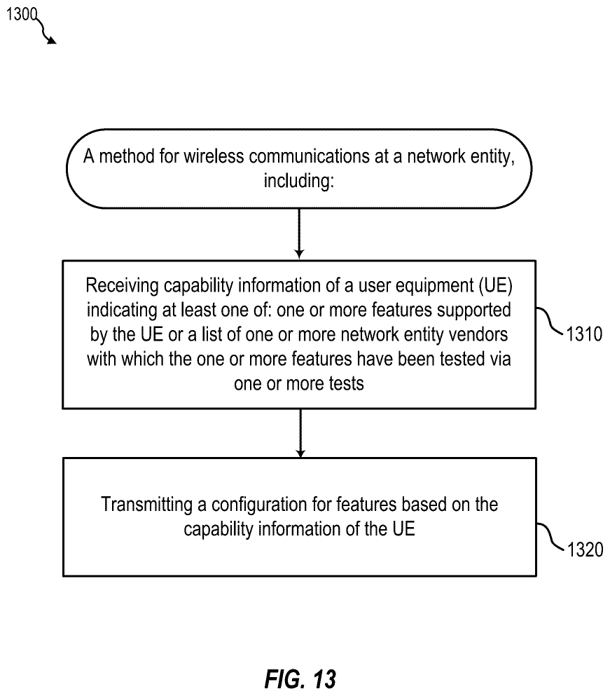

Wireless communication network 100 further includes capability information component 198, which may be configured to perform method 1200 of FIG. 12. Wireless communication network 100 further includes capability information component 199, which may be configured to perform method 1300 of FIG. 13.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

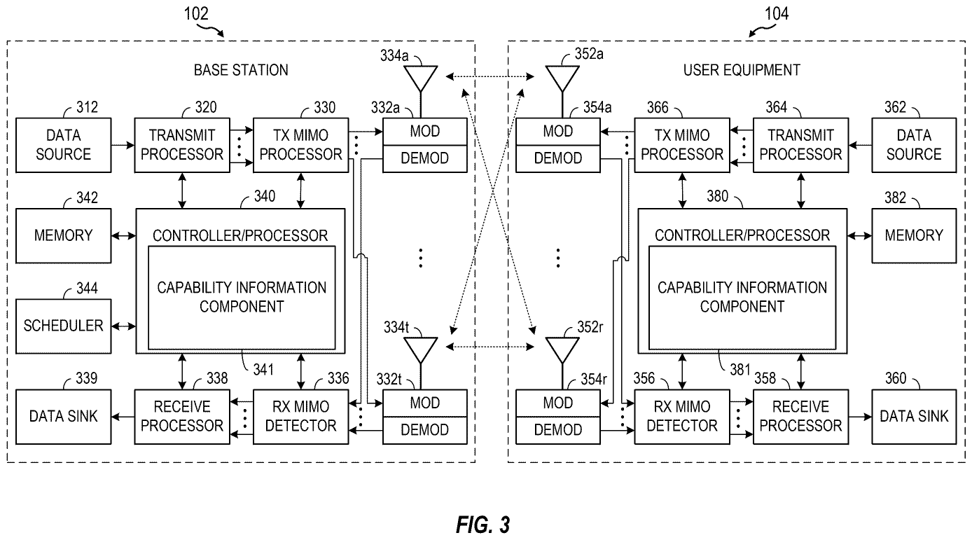

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes capability information component 341, which may be representative of capability information component 199 of FIG. 1. Notably, while depicted as an aspect of controller/processor 340, capability information component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes capability information component 381, which may be representative of capability information component 198 of FIG. 1. Notably, while depicted as an aspect of controller/processor 380, capability information component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

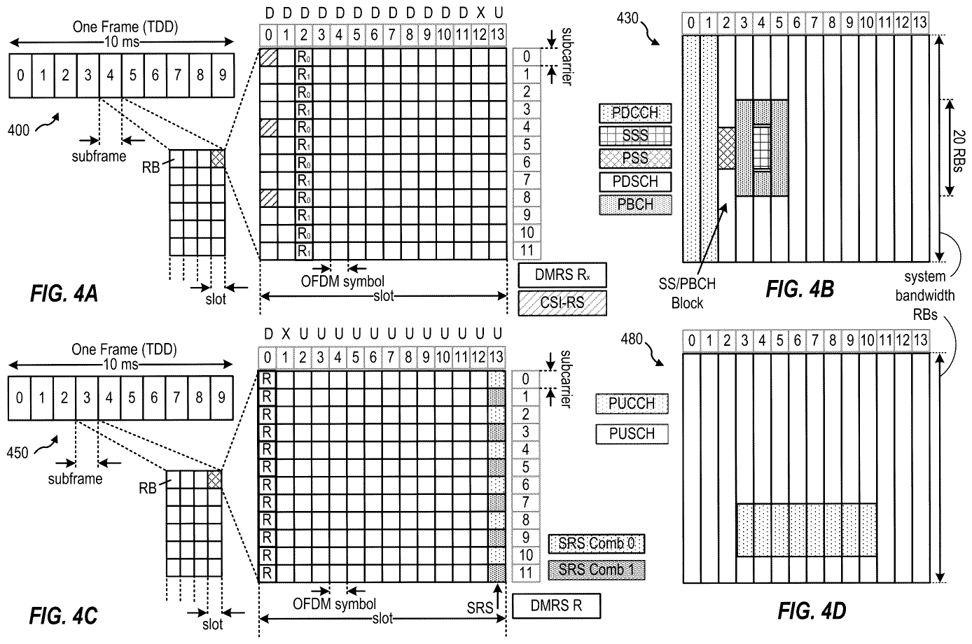

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Mm Wave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHZ, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHZ-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Interoperability Device Testing (IODT)

In modern technology environments, systems are rarely made up of a single device or solution from one manufacturer. Typically, the systems involve components from multiple vendors that need to operate together, whether they are network devices, software platforms, or other technology solutions. Without proper interoperability testing, various devices or systems might fail to work together, leading to inefficiencies, errors, or system failures.

Interoperability device testing (IODT) is an important process that involves testing different devices, equipment, or systems from potentially multiple manufacturers to ensure they can communicate, share data, and function effectively together within a network or system. The main goal is to guarantee seamless interaction across different devices, ensuring they can work together as intended, regardless of brand or specifications.

There are different types of the IODT. For example, inter-device communication testing may ensure that the devices from different vendors can communicate and transfer data correctly. This is particularly important in environments where a multitude of devices may need to exchange data.

End-to-end testing may involve testing the entire system or workflow, and simulating a real-world scenario where all the devices and systems work together. The goal is to verify that data can flow freely from one end to another without any disruptions or loss of information.

The IODT may involve testing how well the devices perform when interacting with each other under various conditions. This might include stress tests to see how they behave under heavy load, or testing for latency and response times when the devices are communicating.

In interconnected systems, ensuring that the devices do not introduce vulnerabilities when communicating is critical. The IODT may include testing to ensure that proper encryption, authentication, and security measures are in place when the devices interact.

The IODT may involve testing the devices for adherence to specific industry standards, such as institute of electrical and electronics engineers (IEEE) for networking devices. Ensuring the devices meet these standards helps ensure the reliability and safety of an overall system.

The IODT may be used in telecommunications systems. For example, in a telecommunications environment, various devices (e.g., base stations, routers, switches, modems) from different vendors and manufacturers need to communicate. The IODT verifies that all components work together in an optimized, seamless way. This includes ensuring that they support common communication protocols like session initiation protocol or internet protocol.

### Overview of Wireless Ecosystem

In wireless ecosystem, every company involved in building a wireless network or device has its own development timeline and plans for what new features it will implement and when. This includes things like performance improvements, new services (e.g., 5^{th} generation (5G) features, enhancements for 6G features), or technological upgrades. These features are typically planned and rolled out according to the development timeline (roadmap) of each company.

The 3rd Generation Partnership Project (3GPP) is the global body responsible for defining standards for mobile networks (e.g., 5G, 6G). Each release (e.g., 5G or 6G) outlines a comprehensive list of features that need to be supported by various network equipment, devices, and systems. These features are defined by 3GPP and have specific benefits, like improving speed, coverage, reliability, or enabling new services.

In the modern wireless ecosystem, a user equipment (UE) vendor (e.g., a smartphone manufacturer, a modem chipset manufacturer, etc.) cannot simply develop features for their devices in isolation. They need to ensure that the features they develop can work seamlessly across different network infrastructure implementations. This means that the UE must be tested with at least two infrastructure vendors (e.g., gNodeB (gNB) vendors, such as gNB vendor A and gNB vendor B) to ensure compatibility. For example, the UE vendor needs to test that their UE can connect and communicate properly with multiple gNBs (from different gNB vendors). This is crucial because each gNB vendor's gNB might interpret the standard in a slightly different way, leading to potential issues. Also, if the new feature is not tested properly with all major gNB vendors, it may not work as expected, leading to degraded user experience. For example, a feature might cause connection drops, poor signal strength, or failed handovers between cells, which would severely impact users' ability to use their UEs.

One of the challenges in this modern wireless ecosystem is that the development timelines (roadmaps) of UE vendors and gNB vendors may not always align. For example, vendor A (one gNB vendor) might be slower in implementing new features (e.g., a new 5G feature or an enhancement to support advanced beamforming) compared to vendor B (another gNB vendor), who may have already implemented the feature a year earlier. This creates a situation where: vendor A gNB might not be ready to support a specific feature, even though the UE vendor device is designed to support it and vendor B gNB could be ready, but since the device isn't tested with the vendor A gNB, it may not be ready for deployment on a network that uses both vendor A infrastructure and vendor B infrastructure.

Since the UE vendors and the gNB vendors may have different timelines, a lot of coordination is required between them to ensure that when a feature is implemented in a UE, it can be tested against the network infrastructure that is available or being deployed at the time. This often means that the UE may need to wait until both the UE vendor and the gNB vendor have the necessary updates or feature implementations aligned.

When a new feature is developed by the UE vendor, it cannot be advertised or used by consumers unless it has been successfully tested with multiple gNB vendors. This ensures the feature works reliably across different network environments. If testing with the multiple gNB vendors cannot be completed in time or due to other reasons (e.g., delays in the adoption of the feature by certain gNB vendors), then the new feature will remain disabled on the UE.

The UE will not advertise its capability to support that feature because it might not work properly with all network infrastructures. For instance, the UE could be capable of supporting a feature X (e.g., a high-speed data transfer or low-latency communication), but if it has not been tested on the major networks (i.e., the gNB vendors), the UE will not enable that feature in a user interface or on a network.

From the consumer perspective, this means that some features might be hidden or unavailable on their UEs because of testing or interoperability issues. It also means that the UE may not deliver its full potential if it's only tested with one vendor's gNB.

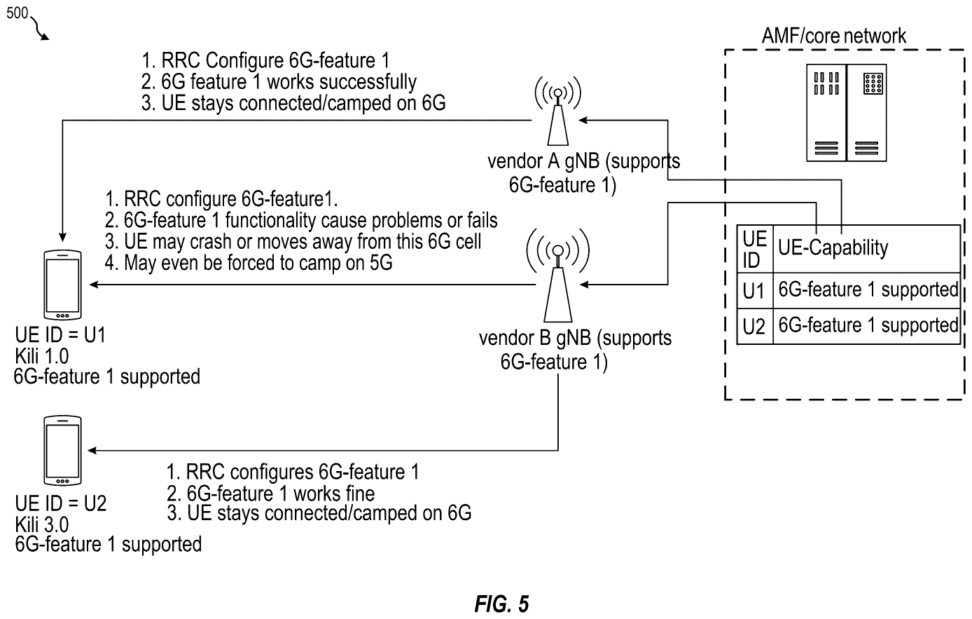

FIG. 5 depicts example wireless communications system 500. The wireless communications system 500 shows communication between a UE 1, a UE 2, a vendor A gNB (i.e., a gNB from a vendor A), a vendor B gNB (i.e., a gNB from a vendor B), and/or an access and mobility management function (AMF)/core network. The UE 1 and the UE 2 may be from different UE vendors. In some cases, the UE 1 and the UE 2 may come from a same UE vendor, but they are released or developed at different times, for example, the UE 1 during year 2025 and the UE 2 during year 2026.

The AMF may store capability information of the UE 1 and the UE 2 that is advertised by the UE 1 and the UE 2. The capability information of the UE 1 and the UE 2 may indicate one or more features supported by the UE 1 and the UE 2. For example, the UE 1 and the UE 2 may support 6G feature 1 for 6G services. The UE 1 may support “Kili 1.0” feature and the UE 2 may support “Kili 3.0” feature. Kili 1.0 and Kili 3.0 are used to represent different modem chipset releases at different times, such as year 2025 and year 2026.

The 6G feature 1 is tested for gNBs from different gNB vendors (e.g., the vendor A gNB and the vendor B gNB) using an interoperability device testing (IODT). The vendor A gNB and the vendor B gNB may support the 6G feature 1.

For instance, the UE 1 may be tested with the vendor A gNB only. For example, the “kili 1.0” feature is tested for the vendor A gNB (i.e., the 6G feature 1 for the UE 1 has been tested with the vendor A gNB).

For instance, the UE 2 may be tested with the vendor A gNB and the vendor B gNB. For example, the “kili 3.0” feature is tested for the vendor A gNB and the vendor B gNB (i.e., the 6G feature 1 for the UE 2 has been tested with the vendor A gNB and the vendor B gNB).

The vendor A gNB may configure (via a radio resource control (RRC) configuration) the 6G feature 1 on the UE 1. The 6G feature 1 operates successfully on the UE 1 and the UE 1 remains connected/camped on 6G service provided by the vendor A gNB. This may be because the 6G feature 1 for the UE 1 has been tested with the vendor A gNB.

The vendor B gNB may configure the 6G feature 1 on the UE 1. The 6G feature 1 does not operate successfully on the UE 1 and the UE 1 may crash or move away from the 6G service provided by the vendor B gNB. The UE 1 may have to move to 5G service, as the 6G service provided by the vendor B gNB is not working properly on the UE 1. This may be because the 6G feature 1 for the UE 1 has been tested with the vendor A gNB and not with the vendor B gNB.

The vendor B gNB may configure the 6G feature 1 on the UE 2. The 6G feature 1 operates successfully on the UE 2 and the UE 2 remains connected/camped on 6G service provided by the vendor B gNB. This may be because the 6G feature 1 for the UE 2 has been tested with the vendor B gNB.

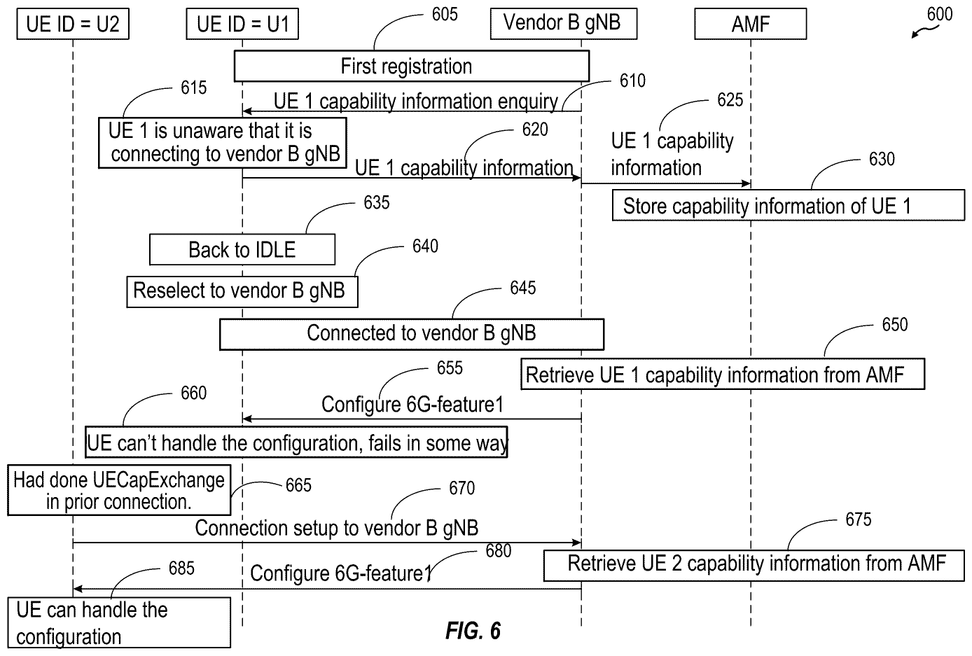

FIG. 6 depicts example flow diagram 600 illustrating communication between multiple devices such as a UE 1, a UE 2, a vendor B gNB, and an AMF (e.g., of the wireless communications system 500 of FIG. 5).

At 605, the UE 1 registers with the vendor B gNB.

At 610, the vendor B gNB sends an enquiry request to the UE 1 for capability information of the UE 1.

At 615, the UE 1 is unaware that it is being connected to the vendor B gNB.

At 620, the UE 1 sends its capability information to the vendor B gNB. The capability information of the UE 1 may indicate or advertise that the UE 1 supports 6G feature 1. The 6G feature 1 for the UE 1 has been tested for a vendor A gNB.

At 625, the vendor B gNB sends the capability information of the UE 1 to the AMF.

At 630, the AMF stores the capability information of the UE 1.

At 635, the UE 1 moves to an idle state.

At 640, the UE 1 reselects the vendor B gNB.

At 645, the UE 1 connects to the vendor B gNB.

At 650, the vendor B gNB retrieves the capability information of the UE 1 from the AMF. The capability information of the UE 1 may indicate that the UE 1 supports 6G feature 1.

At 655, the vendor B gNB configures the 6G feature 1 on the UE 1.

At 660, the UE 1 is unable to handle configuration of the 6G feature 1 provided by the vendor B gNB. For example, the 6G feature 1 does not operate successfully on the UE 1 and the UE 1 may crash or move away from 6G service provided by the vendor B gNB. This may be because the 6G feature 1 for the UE 1 has not been tested for the vendor B gNB.

At 665, it is assumed that the UE 2 has performed exchange of capability information of the UE 2 with the vendor B gNB during its prior connection with the vendor B gNB. The capability information of the UE 2 may indicate that the UE 2 supports the 6G feature 1. The 6G feature 1 for the UE 2 has been tested for the vendor A gNB and the vendor B gNB.

At 670, the UE 2 connects to the vendor B gNB.

At 675, the vendor B gNB retrieves the capability information of the UE 2 from the AMF. The capability information of the UE 2 may indicate that the UE 2 supports the 6G feature 1.

At 680, the vendor B gNB configures the 6G feature 1 on the UE 2.

At 685, the 6G feature 1 operates successfully on the UE 2 and the UE 2 remains connected/camped on the 6G service provided by the vendor B gNB. This may be because the 6G feature 1 for the UE 2 has been tested for the vendor B gNB.

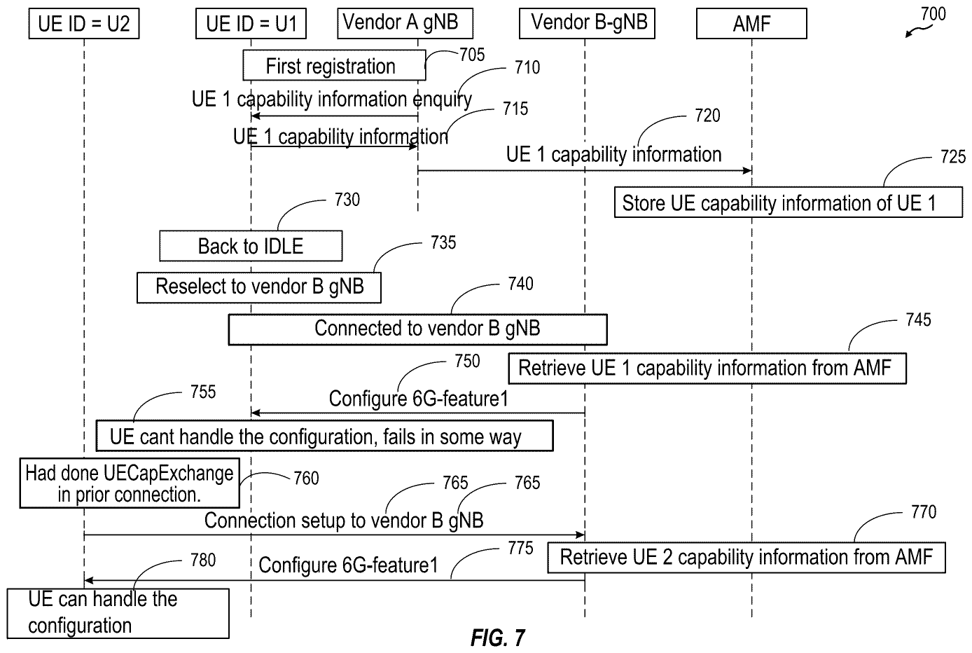

FIG. 7 depicts another example flow diagram 700 illustrating communication between multiple devices such as a UE 1, a UE 2, a vendor A gNB, a vendor B gNB, and an AMF (e.g., of the wireless communications system 500 of FIG. 5).

At 705, the UE 1 registers with the vendor A gNB.

At 710, the vendor A gNB sends an enquiry request to the UE 1 for capability information of the UE 1.

At 715, the UE 1 sends its capability information to the vendor A gNB. The capability information of the UE 1 may indicate or advertise that the UE 1 supports 6G feature 1. The 6G feature 1 for the UE 1 has been tested for the vendor A gNB.

At 720, the vendor A gNB sends the capability information of the UE 1 to the AMF.

At 725, the AMF stores the capability information of the UE 1.

At 730, the UE 1 moves to an idle state.

At 735, the UE 1 reselects the vendor B gNB.

At 740, the UE 1 connects to the vendor B gNB.

At 745, the vendor B gNB retrieves the capability information of the UE 1 from the AMF. The capability information of the UE 1 may indicate that the UE 1 supports the 6G feature 1.

At 750, the vendor B gNB configures the 6G feature 1 on the UE 1.

At 755, the UE 1 is unable to handle configuration of the 6G feature 1 provided by the vendor B gNB. For example, the 6G feature 1 does not operate successfully on the UE 1 and the UE 1 may crash or move away from 6G service provided by the vendor B gNB. This may be because the 6G feature 1 for the UE 1 has not been tested for the vendor B gNB.

At 760, it is assumed that the UE 2 has performed exchange of capability information of the UE 2 with the vendor B gNB during its prior connection with the vendor B gNB. The capability information of the UE 2 may indicate that the UE 2 supports the 6G feature 1. The 6G feature 1 for the UE 2 has been tested for the vendor A gNB and the vendor B gNB.

At 765, the UE 2 connects to the vendor B gNB.

At 770, the vendor B gNB retrieves the capability information of the UE 2 from the AMF. The capability information of the UE 2 may indicate that the UE 2 supports the 6G feature 1.

At 775, the vendor B gNB configures the 6G feature 1 on the UE 2.

At 780, the 6G feature 1 operates successfully on the UE 2 and the UE 2 remains connected/camped on the 6G service provided by the vendor B gNB. This may be because the 6G feature 1 for the UE 2 has been tested for the vendor B gNB.

### Aspects Related to Enabling Wireless Features on a UE

Techniques described herein may enable a user equipment (UE) to advertise to a network device that the UE is capable of supporting a particular wireless feature. The UE may also specify whether this support for the particular wireless feature is limited to certain specific vendors of a gNodeB (gNB). For example, the UE may include information that details which specific gNB vendors the particular wireless feature has been successfully tested with during an interoperability device testing (IODT) process. This testing ensures that the particular wireless feature functions properly in real-world conditions and with various gNB vendor implementations. Based on this information, the network device will be expected to refrain from configuring the UE with the particular wireless feature if the particular wireless feature has not been tested and proven to work with the vendor's specific gNB equipment. For instance, the network device may be expected to configure the UE with the particular wireless feature only when the particular wireless feature has been tested and proven to work with the vendor's specific gNB equipment. This ensures a higher level of interoperability and reliability for the use of the wireless feature supported by the UE with gNBs from different gNB vendors.

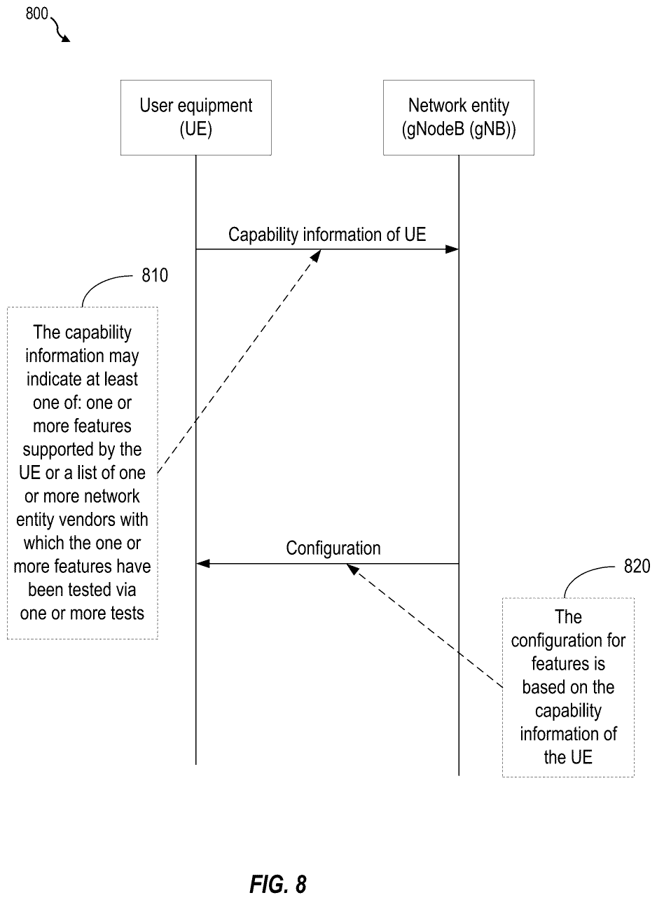

The techniques proposed herein for managing enabling of wireless features on a UE may be further understood with reference to FIG. 8-FIG. 15.

FIG. 8 depicts a call flow diagram 800 illustrating example communication among a UE and a network entity (e.g., a gNB) for managing enabling of wireless features. The UE shown in FIG. 8 may be an example of the UE 104 depicted and described with respect to FIG. 1 and FIG. 3. The gNB depicted in FIG. 8 may be an example of the BS 102 depicted and described with respect to FIG. 1 and FIG. 3, or the disaggregated BS depicted and described with respect to FIG. 2.

As indicated at 810, the UE sends capability information of the UE to the gNB. The capability information may indicate one or more features (e.g., wireless features) supported by the UE. The capability information may also indicate a list of one or more gNB vendors with which the one or more features have been tested via one or more tests. The one or more tests may include an interoperability device testing (IODT).

As indicated at 820, the gNB sends a configuration for features (e.g., which may be based on the capability information of the UE) to the UE.

In certain aspects, the capability information may indicate, for each feature supported by the UE, a name or an identifier (ID) of each gNB vendor with which the each feature has been tested. For example, for each feature (e.g., a layer 1 (L1)/L2 triggered mobility (LTM) L3 measurement report feature, a LTM L1 measurement report feature) supported by the UE, the UE may include (e.g., in the capability information) a list of gNB vendor names (e.g., a list of UTF8 strings) with which the IODT test was done for the each feature. If any feature (e.g., a frequency range (FR) 2 gapless feature) is un-restricted, i.e., may be enabled across all gNB vendors, the UE may also include such indication in the capability information.

One example of the capability information of the UE (e.g., which may specify that the LTM L3 measurement report feature is tested with a gNB vendor A, the LTM L1 measurement report feature is tested with gNB vendors B and C, the FR 2 gapless feature is tested with all gNB vendors) is as follows:

HighLevelFeatures
{
LTM-L3-measurement report { gNB vendor A},
LTM-L1-measurement report {gNb vendor B, gNodeB vendor C},
FR2-gapless { All }
}

In certain aspects, the capability information may indicate, for each feature supported by the UE, a hash value of a string corresponding to each gNB vendor with which the each feature has been tested. The string may include a sequence of characters. The string may be decided via pre-communication between a vendor of the UE and each gNB vendor. For example, for each feature (e.g., the LTM L3 measurement report feature, the LTM L1 measurement report feature) supported by the UE, the UE may include (e.g., in the capability information) a list of hash values of pre-agreed strings that may map to specific gNB vendor names (i.e., the UE may obfuscate the gNB vendor names indicated in the capability information) with which the IODT test was done for the each feature. If any feature (e.g., the FR 2 gapless feature) is enabled across all gNB vendors, the UE may also include such indication in the capability information. The pre-agreed string may need to be exchanged between companies outside of 3^{rd} generation partnership project (3GPP).

One example of the capability information of the UE (e.g., which may specify that the LTM L3 measurement report feature is tested with the gNB vendor A (e.g., represented by hash value bf07bcfb12fe3b . . . ), the LTM L1 measurement report feature is tested with the gNB vendor B (e.g., represented by hash value 9560a0db1 . . . ) and the gNodeB vendor C (e.g., represented by hash value b8ceac8361b . . . ), the FR 2 gapless feature is tested with all gNB vendors) is as follows:

HighLevelFeatures
{
LTM-L3-measurement report {bf07bcfb121fe3b . . . },
LTM-L1-measurement report {9560a0db1 . . . , b8ceac8361b . . . },
FR2-gapless {All}
}

In certain aspects, the capability information may indicate, for each feature supported by the UE, a code value corresponding to each gNB vendor with which the each feature has been tested. For example, like mobile country code (MCC)-mobile network code (MNC) code, a network operator may decide a mobile infrastructure/gNB code corresponding to a gNB vendor, which may be based on a first format (e.g., 2 decimal digit) or a second format (e.g., 7 bits). Per the first format, 10 may be assigned for the gNB vendor A, 15 may be assigned for the gNB vendor B, 33 may be assigned for the gNB vendor C, and so on. Per the second format, one bit may be assigned to a gNB vendor used by an operator. For example, bit 1 for the gNB vendor A, bit 2 for the gNB vendor B, bit 3 for the gNB vendor C, and so on. A UE vendor may work with the operator to ensure correct mapping of bits in the UE capability information, based on the IODT status.

One example of the capability information of the UE (e.g., which may specify that the LTM L3 measurement report feature is tested with the gNB vendor A (e.g., represented by code value 10), the LTM L1 measurement report feature is tested with the gNB vendor B (e.g., represented by code value 15) and the gNodeB vendor C (e.g., represented by code value 33), the FR 2 gapless feature is tested with all gNB vendors) is as follows:

HighLevelFeatures
{
LTM-L3-measurement report {10},
LTM-L1-measurement report {15,33},
FR2-gapless {All}
}

Another example of the capability information of the UE (e.g., which may specify that the LTM L3 measurement report feature is tested with at least one gNB vendor (e.g., represented by code value 00000010), the LTM L1 measurement report feature is tested with at least two gNB vendors (e.g., represented by code value 00001100) and the FR 2 gapless feature is tested with at least one gNodeB vendor (e.g., represented by code value 00000001)) is as follows:

HighLevelFeatures
{
LTM-L3-measurement report {00000010},
LTM-L1-measurement report {00001100},
FR2-gapless {00000001}
}

In the above example, a single bit string in the code value may indicate all gNB infrastructure vendors with which the UE was tested. For example, the code value 00001100 has bit 2 and bit 3 as 1. The bit 2 indicates one gNB vendor with which the UE is tested and the bit 3 indicates another gNB vendor with which the UE is tested.

In certain aspects, the capability information may indicate, for each feature supported by the UE, a private enterprise number corresponding to each gNB vendor with which the each feature has been tested. For example, for each feature (e.g., the LTM L3 measurement report feature, the LTM L1 measurement report feature) supported by the UE, the UE may include (e.g., in the capability information) a list of private enterprise numbers of gNB vendors with which the IODT test was done for the each feature. A private enterprise number issued by internet assigned numbers authority (IANA) may be a decimal number in a range between 0 and 4294967295 that needs to be converted to a fixed length 8 digit hexadecimal number when used within the UE capability information. For example, 32473 is converted to 00007ED9.

One example of the capability information of the UE (e.g., which may specify that the LTM L3 measurement report feature is tested with the gNB vendor A (e.g., represented by private enterprise number 193), the LTM L1 measurement report feature is tested with the gNB vendor B (e.g., represented by private enterprise number 94) and the gNodeB vendor C (e.g., represented by private enterprise number 21744), the FR 2 gapless feature is tested with all gNB vendors) is as follows:

HighLevelFeatures
{
LTM-L3-measurement report {193},
LTM-L1-measurement report {94, 21744},
FR2-gapless {All}
}

In certain aspects, the capability information may indicate, for each feature supported by the UE, a bit value corresponding to each gNB vendor with which the each feature has been tested. Different bit values may be mapped to different gNB vendors, based on an input from an operator of a subscriber identity module (SIM) card for the UE. For example, the SIM card from a network operator may include a list of gNB vendors to infrastructure/gNB bits mapping as shown in table 1 below. The UE may use the bits mapping shown in the table 1 while setting the list of gNB vendors for the each feature.

Example table 1 is shown below:

TABLE 1

| | Bit to be used in UE |
|---|---|
| SIM card | capability information |
| gNB vendor A | Bit 1 |
| gNB vendor B | Bit 2 |
| gNB vendor C | Bit 3 |

In some cases, in the capability information of the UE, the LTM L3 measurement report supported by the gNB vendor A may be represented by 00000010, the LTM L1 measurement report supported by the gNB vendor B only may be represented by 00000100, and the FR2 gapless supported by all gNB vendors may be represented by 00000001.

In certain aspects, information associated with the one or more features supported by the UE for each gNB vendor may be carried in an encrypted manner in a container corresponding to the gNB vendor. For example, some techniques may rely on the gNB honoring a gNB vendor list advertised by the UE, ensuring that features are not enabled if the gNB's vendor name is not listed. However, the UE has no way to validate whether an IODT test for a specific feature was conducted with a currently connected gNB, as the UE is unaware of the gNB vendor of the currently connected gNB. So, in some cases, one technique may be implemented that may securely transfer infrastructure/gNB specific portion of the UE capability information, ensuring that it is only configured by the gNB with which the IODT test was performed. Additionally, the 3GPP may introduce an gNB-specific container at different levels within the UE capability information if required. For instance, with this mechanism, only a gNB vendor A will be able to decrypt the UE capability information container, guaranteeing that only the gNB vendor A can enable or configure the features that were IODT tested with the gNB vendor A. An example capability information container is as follows:

```
ue-CapabilityRAT-ContainerList
{
    rat-Type nr,
    ue-CapabilityRAT-Container octet string
}{
          {
rat-Type nr-infra,
infra gNB vendor A # or Private Enterprise Number of gNB vendor A
ue-CapabilityRAT-Container octet string - #encrypted with gNB vendor A
public key
}
```

In the above-noted capability information container, an encrypted “nr-infra” specific container may represent a list of features enabled for the gNB vendor A as shown below:

HighLevelFeatures
{
LTM-L3-measurement report {gNB vendor A}
}

In certain aspects, the UE may receive signaling carrying a table including a mapping of the different bit values to the different gNB vendors. The UE may use information in the table to generate the capability information including the list of the one or more gNB vendors with which the one or more features have been tested. For example, non-access stratum (NAS) signaling from a network device may include a table 2 showing the list of gNB vendors to the infrastructure/gNB bits mapping. The UE may use this bits mapping while setting the list of infrastructure/gNB vendors for the each feature.

Example table 2 is shown below:

TABLE 2

| NAS signaling list of gNB vendors | Bit to be used in UE |
|---|---|
| in carrier/deployment | capability information |
| gNB vendor A | Bit 1 |
| gNB vendor B | Bit 2 |
| gNB vendor C | Bit 3 |

In some cases, in the capability information of the UE, the LTM L3 measurement report supported by the gNB vendor A may be represented by 00000010, the LTM L1 measurement report supported by the gNB vendor B and the gNB vendor C may be represented by 00001100, and the FR2 gapless supported by all gNB vendors may be represented by 00000001.

In certain aspects, the UE may establish a connection with a first gNB. The UE may send, to an access and mobility management function (AMF) based on the connection with the first gNB, a registration or a service request. The UE may receive, from the AMF in response to the registration or the service request, a response message including information corresponding to a vendor of the first gNB. The information corresponding to the vendor of the first gNB may be received by the UE via NAS signaling and/or multicast broadcast services (MBS).

In certain aspects, the UE may determine whether the one or more features supported by the UE that are stated in the capability information of the UE have been tested for the vendor of the first gNB. The UE may update the capability information in accordance with the determination. For example, the UE may update the capability information of the UE to indicate that the one or more features are not supported by the UE when the one or more features have not been tested for the vendor of the first gNB.

In certain aspects, the UE may move from a connection with the first gNB associated with a first vendor to a second gNB associated with a second vendor. The UE may receive, from the AMF, information corresponding to the second vendor of the second gNB.

In certain aspects, the capability information of the UE may be advertised based on the connection with the first gNB associated with the first vendor. The one or more features supported by the UE that are stated in the capability information of the UE may have been tested for at least the first vendor of the first gNB.

In certain aspects, the UE may determine whether the one or more features supported by the UE that are stated in the capability information of the UE have also been tested for the second vendor of the second gNB. The UE may update the capability information of the UE in accordance with the determination. For example, the UE may update the capability information of the UE to indicate that the one or more features are not supported by the UE when the one or more features have not been tested for the second vendor of the second gNB.

### Example Systems and Techniques to Enable UE Features Based on IODT Status

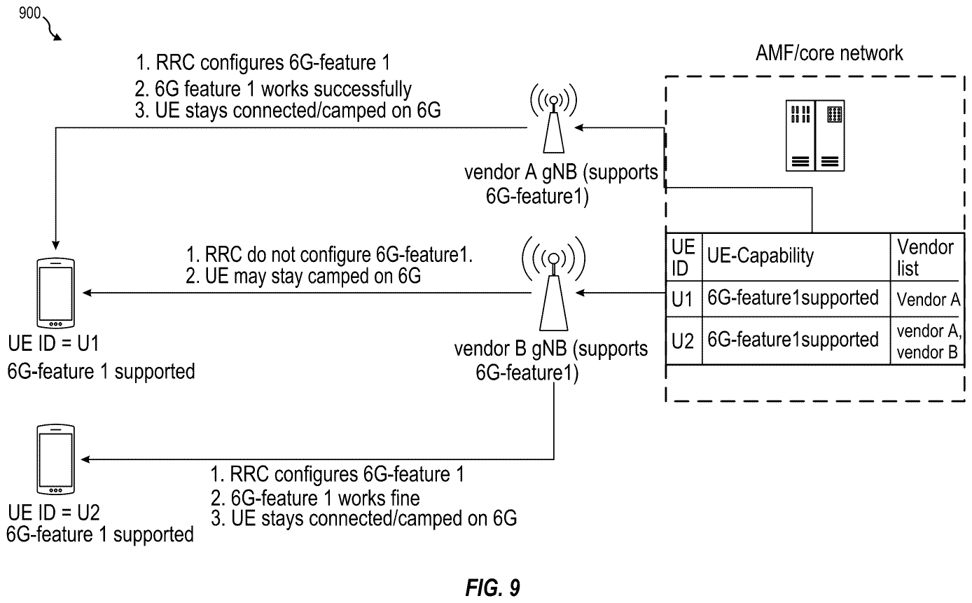

FIG. 9 depicts example wireless communications system 900. The wireless communications system 900 shows communication between a user equipment (UE) 1, a UE 2, a vendor A gNodeB (gNB) (i.e., gNB from vendor A), a vendor B gNB (i.e., gNB from vendor B), and/or an access and mobility management function (AMF)/core network. The UE 1 and the UE 2 may be from different UE vendors.

The AMF may store capability information of the UE 1 and the UE 2 that is advertised by the UE 1 and the UE 2. The capability information of the UE 1 and the UE 2 may indicate one or more features supported by the UE 1 and the UE 2. For example, the UE 1 may support 6G feature 1 for 6G services with the vendor A gNB (i.e., the 6G feature 1 for the UE 1 has been tested with the vendor A gNB) per the capability information of the UE 1. The UE 2 may support the 6G feature 1 for the 6G services with the vendor A gNB and the vendor B gNB (i.e., the 6G feature 1 for the UE 2 has been tested with the vendor A gNB and the vendor B gNB) per the capability information of the UE 2.

The vendor A gNB may configure (via a radio resource control (RRC) configuration) the 6G feature 1 on the UE 1, based on the capability information of the UE 1. The 6G feature 1 operates successfully on the UE 1 and the UE 1 remains connected/camped on 6G service provided by the vendor A gNB. This may be because the 6G feature 1 for the UE 1 has been tested with the vendor A gNB.

The vendor B gNB may not configure the 6G feature 1 on the UE 1, based on the capability information of the UE 1. This may be because the capability information of the UE 1 indicates that the 6G feature 1 for the UE 1 has been tested with the vendor A gNB only.

The vendor B gNB may configure the 6G feature 1 on the UE 2, based on the capability information of the UE 2. The 6G feature 1 operates successfully on the UE 2 and the UE 2 remains connected/camped on 6G service provided by the vendor B gNB. This may be because the 6G feature 1 for the UE 2 has been tested with the vendor B gNB.

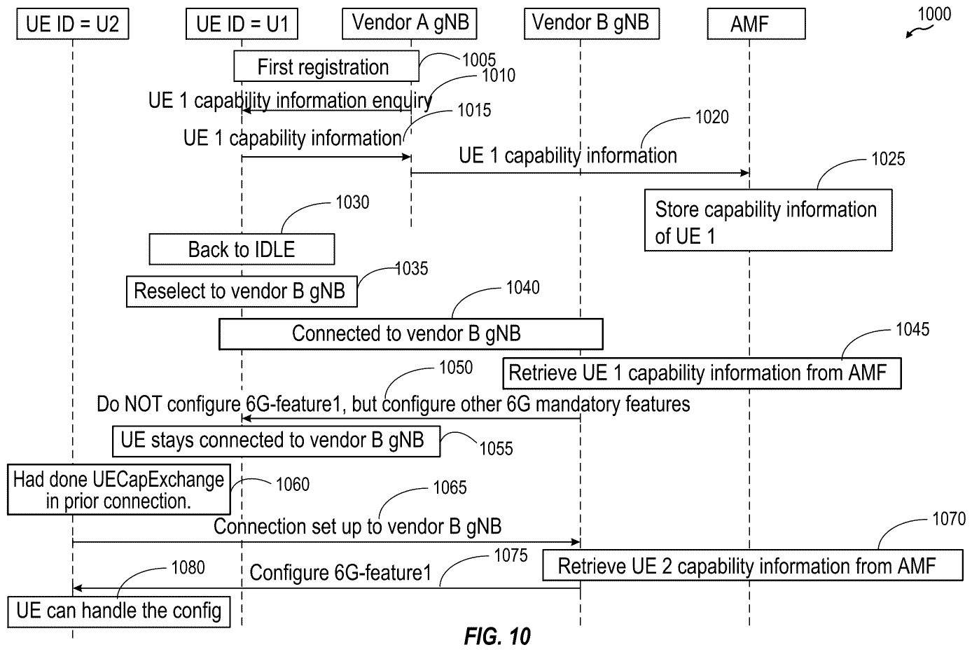

FIG. 10 depicts example flow diagram 1000 illustrating communication between multiple devices such as a UE 1, a UE 2, a vendor A gNB, a vendor B gNB, and an AMF/core network (e.g., of the wireless communications system 900 of FIG. 9).

At 1005, the UE 1 registers with the vendor A gNB.

At 1010, the vendor A gNB sends an enquiry request to the UE 1 for capability information of the UE 1.

At 1015, the UE 1 sends its capability information to the vendor A gNB. The capability information of the UE 1 may specify that the UE 1 may support 6G feature 1 with the vendor A gNB (i.e., the 6G feature 1 for the UE 1 has been tested with the vendor A gNB).

At 1020, the vendor A gNB sends the capability information of the UE 1 to the AMF.

At 1025, the AMF stores the capability information of the UE 1.

At 1030, the UE 1 moves to an idle state.

At 1035, the UE 1 reselects the vendor B gNB.

At 1040, the UE 1 connects to the vendor B gNB.

At 1045, the vendor B gNB retrieves the capability information of the UE 1 from the AMF. The capability information of the UE 1 may specify that the UE 1 may support the 6G feature 1 with the vendor A gNB.

At 1050, the vendor B gNB does not configure the 6G feature 1 on the UE 1. This may be because the capability information of the UE 1 indicates that the 6G feature 1 for the UE 1 has been tested with the vendor A gNB only.

At 1055, the UE 1 stays connected to the vendor B gNB.

At 1060, it is assumed that the UE 2 has performed exchange of capability information of the UE 2 with the vendor B gNB during its prior connection with the vendor B gNB. The capability information of the UE 2 may specify that the UE 2 may support the 6G feature 1 with the vendor A gNB and the vendor B gNB (i.e., the 6G feature 1 for the UE 2 has been tested with the vendor A gNB and the vendor B gNB).

At 1065, the UE 2 connects to the vendor B gNB.

At 1070, the vendor B gNB retrieves the capability information of the UE 2 from the AMF. The capability information of the UE 2 may specify that the UE 2 may support the 6G feature 1 with the vendor A gNB and the vendor B gNB.

At 1075, the vendor B gNB configures the 6G feature 1 on the UE 2.

At 1080, the 6G feature 1 operates successfully on the UE 2 and the UE 2 remains connected/camped on the 6G service provided by the vendor B gNB. This may be because the 6G feature 1 for the UE 2 has been tested for the vendor B gNB.

In certain aspects, when a UE connects to a gNB for a first time, a core network provides information in a message to the UE about a vendor that the gNB belongs to. This is communicated to the UE through a signaling mechanism called non-access stratum (NAS) signaling. The message may be part of the signaling process between the UE and the core network, used to establish or confirm the connection. The message also carries other details like the gNB vendor information. Common vendors include companies like Ericsson, Nokia, etc. This information may help the UE understand the specific characteristics of the gNB it is connecting to.

The UE may store certain capabilities (like supported wireless features, frequencies, protocols, etc.) that it advertises to the core network. When the UE receives the gNB vendor information, the UE checks whether the received gNB vendor information requires an update to the UE's advertised capabilities to the core network. If the received gNB vendor information indicates that the UE's current capabilities are no longer optimal or compatible with the gNB, the UE may need to update its advertised capabilities to the core network. For example, if the UE supports a certain wireless feature that the gNB does not (since the gNB has not tested the wireless feature), the UE might need to adjust its capabilities.

In a handover situation, the UE is moving from one gNB to another gNB, and a target gNB may be from a different vendor than a current gNB. In this case, the core network can initiate the NAS signaling to notify the UE of the vendor change. For example, the handover may be a process where the UE moves from one gNB to another, possibly to maintain service when the UE is on the move. When this happens across different gNB vendors (for instance, moving from a gNB of a vendor A to a gNB of a vendor B), the core network may need to communicate to the UE that there is a change in the gNB vendor. Based on the gNB vendor change, the UE may need to update its advertised capabilities. For example, the UE may need to inform the core network about its updated supported features, supported bands, or other capabilities in response to the new gNB's capabilities.

The system information block (SIB) is a mechanism that may be used by the core network to broadcast various pieces of information to the UE. For example, the core network can use SIBs to broadcast information about the gNB vendor that operates the gNB. There is also an option for the core network to use MBS (multimedia broadcast and multicast service) to broadcast gNB-specific information. For example, this could be used to send out gNB-specific vendor information, including which gNB vendor is operating the gNB associated with the UE.

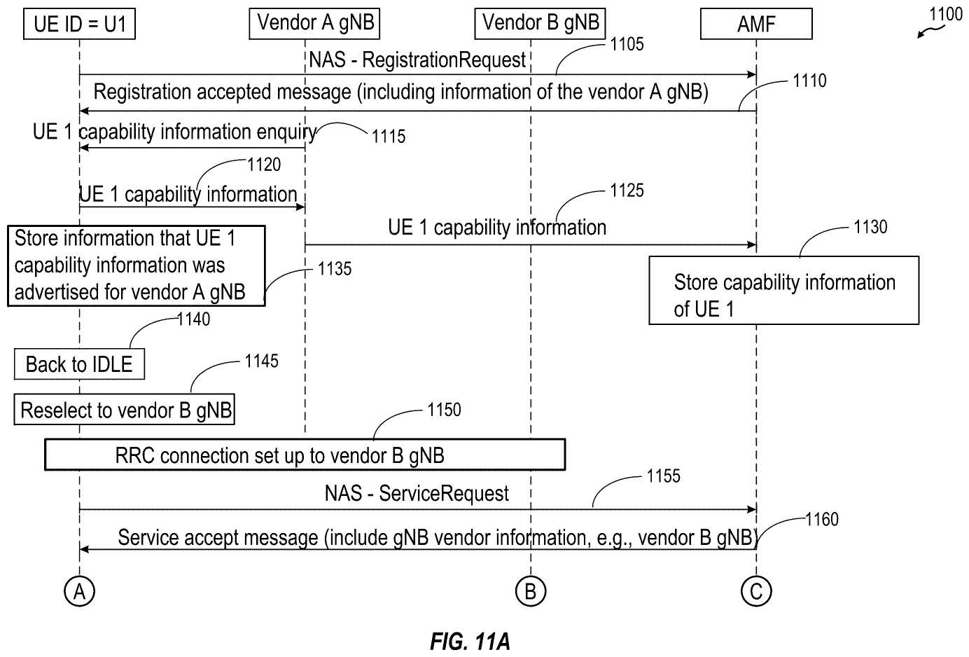

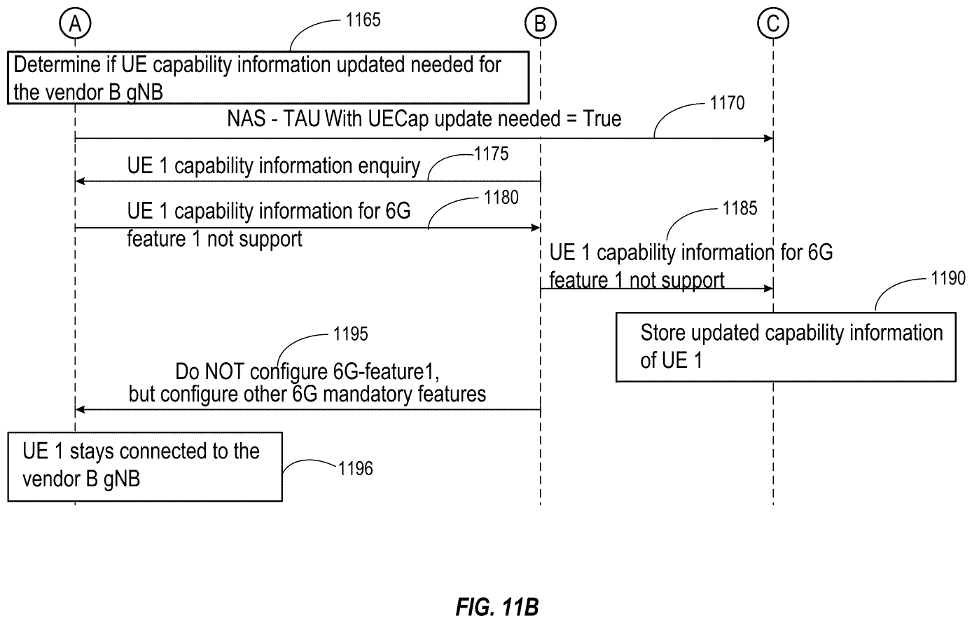

FIG. 11A and FIG. 11B depict example flow diagram 1100 illustrating communication between multiple devices such as a UE 1, a vendor A gNB, a vendor B gNB, and an AMF/core network (e.g., of the wireless communications system 900 of FIG. 9).

At 1105, the UE 1 sends a NAS registration request to the AMF (as the UE 1 is connected to the vendor A gNB).

At 1110, the AMF sends a message to the UE 1 indicating an acceptance of the NAS registration request. The message may also indicate vendor information of the vendor A gNB.

At 1115, the vendor A gNB sends an enquiry request to the UE 1 for capability information of the UE 1.

At 1120, the UE 1 sends its capability information to the vendor A gNB. The capability information of the UE 1 may specify that the UE 1 may support 6G feature 1 with the vendor A gNB (i.e., the 6G feature 1 for the UE 1 has been tested with the vendor A gNB).

At 1125, the vendor A gNB sends the capability information of the UE 1 to the AMF.

At 1130, the AMF stores the capability information of the UE 1.

At 1135, the UE 1 stores information that the capability information of the UE 1 has been advertised for the vendor A gNB (i.e., the UE 1 supports the 6G feature 1 with the vendor A gNB).

At 1140, the UE 1 moves to an idle state.

At 1145, the UE 1 reselects the vendor B gNB.

At 1150, the UE 1 connects to the vendor B gNB.

At 1155, the UE 1 sends a NAS service request to the AMF (as the UE 1 is connected to the vendor B gNB).

At 1160, the AMF sends a message to the UE 1 indicating an acceptance of the NAS service request. The message may also indicate vendor information of the vendor B gNB.

At 1165, the UE 1 determines whether the capability information of the UE 1 has to be updated for the vendor B gNB.

At 1170, the UE 1 sends a message to the AMF that the capability information of the UE 1 has to be updated (e.g., to indicate that the UE 1 does not support the 6G feature 1 with the vendor B gNB).

At 1175, the vendor B gNB sends an enquiry request to the UE 1 for the capability information of the UE 1.

At 1180, the UE 1 sends its capability information to the vendor B gNB. The capability information of the UE 1 may specify that the UE 1 does not support the 6G feature 1 with the vendor B gNB.

At 1185, the vendor B gNB sends the capability information of the UE 1 to the AMF. The capability information of the UE 1 may specify that the UE 1 does not support the 6G feature 1 with the vendor B gNB.

At 1190, the AMF stores the capability information of the UE 1.

At 1195, the vendor B gNB does not configure the 6G feature 1 on the UE 1. This may be because the capability information of the UE 1 indicates that the 6G feature 1 for the UE 1 has not been tested with the vendor B gNB.

At 1196, the UE 1 stays connected to the vendor B gNB.

### Example Methods for Wireless Communications

FIG. 12 shows an example of a method 1200 for wireless communications at a wireless node such as a user equipment (UE). The UE may be the UE 104 of FIG. 1 and FIG. 3.

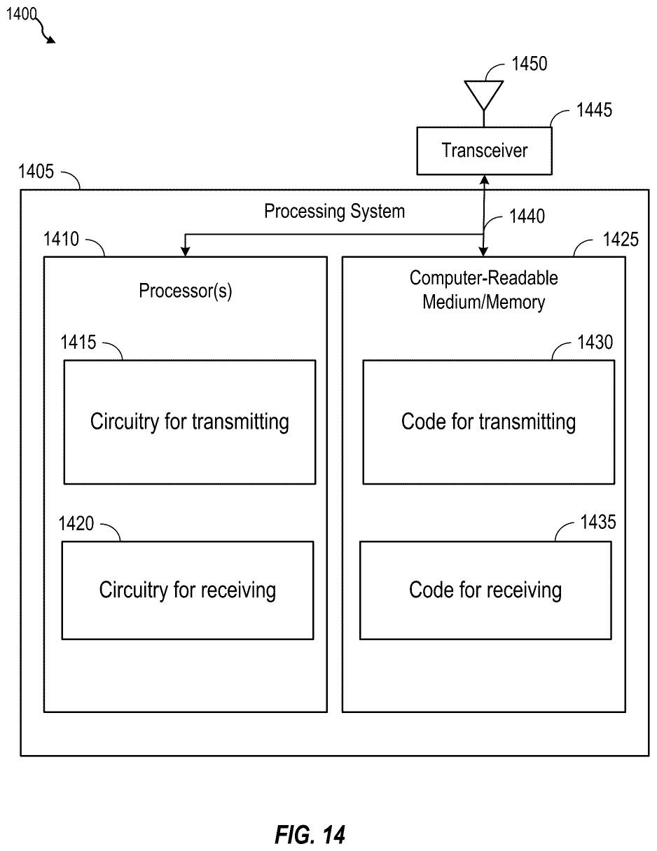

Method 1200 begins at 1210 with transmitting capability information indicating at least one of: one or more features supported by the UE or a list of one or more network entity vendors with which the one or more features have been tested via one or more tests. In some cases, the operations of this step refer to, or may be performed by, circuitry for transmitting and/or code for transmitting as described with reference to FIG. 14.

Method 1200 then proceeds to 1220 with receiving a configuration for features based on the capability information. In some cases, the operations of this step refer to, or may be performed by, circuitry for receiving and/or code for receiving as described with reference to FIG. 14.

In certain aspects, the one or more tests include an interoperability device testing (IODT).

In certain aspects, the capability information indicates, for each feature supported by the UE, a name or an identifier (ID) of each network entity vendor with which the each feature has been tested.

In certain aspects, the capability information indicates, for each feature supported by the UE, a hash value of a string corresponding to each network entity vendor with which the each feature has been tested; the string includes a sequence of characters; and the string is decided via pre-communication between a vendor of the UE and each network entity vendor.

In certain aspects, the capability information indicates, for each feature supported by the UE, a code value corresponding to each network entity vendor with which the each feature has been tested.

In certain aspects, the capability information indicates, for each feature supported by the UE, a private enterprise number corresponding to each network entity vendor with which the each feature has been tested.

In certain aspects, the capability information indicates, for each feature supported by the UE, a bit value corresponding to each network entity vendor with which the each feature has been tested, and wherein different bit values are mapped to different network entity vendors based on an input from an operator of a subscriber identity module (SIM) card for the UE.

In certain aspects, information associated with the one or more features supported by the UE for each network entity vendor is carried in an encrypted manner in a container corresponding to the network entity vendor.

In certain aspects, the method 1200 further includes receiving signaling carrying a table including a mapping of the different bit values to the different network entity vendors; and using the table to generate the capability information including the list of the one or more network entity vendors with which the one or more features have been tested.

In certain aspects, the method 1200 further includes establishing a connection with a first network entity; transmitting, to an access and mobility management function (AMF) based on the connection with the first network entity, a registration or a service request; and receiving, from the AMF in response to the registration or the service request, a response message including information corresponding to a vendor of the first network entity.

In certain aspects, the information corresponding to the vendor of the first network entity is received via at least one of: non-access stratum (NAS) signaling or multicast broadcast services (MBS).

In certain aspects, the method 1200 further includes determining whether the one or more features supported by the UE that are stated in the capability information have been tested for the vendor of the first network entity; and updating the capability information in accordance with the determination.

In certain aspects, the method 1200 further includes updating the capability information to indicate that the one or more features are not supported by the UE when the one or more features have not been tested for the vendor of the first network entity.

In certain aspects, the method 1200 further includes moving from a connection with a first network entity associated with a first vendor to a second network entity associated with a second vendor; and receiving, from an access and mobility management function (AMF), information corresponding to the second vendor of the second network entity.

In certain aspects, the capability information is advertised based on the connection with the first network entity associated with the first vendor; and the one or more features supported by the UE that are stated in the capability information have been tested for at least the first vendor of the first network entity.

In certain aspects, the method 1200 further includes determining whether the one or more features supported by the UE that are stated in the capability information have been tested for the second vendor of the second network entity; and updating the capability information in accordance with the determination.

In certain aspects, the method 1200 further includes updating the capability information to indicate that the one or more features are not supported by the UE when the one or more features have not been tested for the second vendor of the second network entity.

In one aspect, the method 1200, or any aspect related to it, may be performed by an apparatus, such as a wireless node 1400 of FIG. 14, which includes various components operable, configured, or adapted to perform the method 1200. The wireless node 1400 is described below in further detail.

Note that FIG. 12 is just one example of a method, and other methods including fewer, additional, or alternative steps are possible consistent with this disclosure.

FIG. 13 shows an example of a method 1300 for wireless communications at a wireless node such as a network entity. The network entity may be the 5GC 190 of FIG. 1, or the BS 102 of FIG. 1 and FIG. 3.

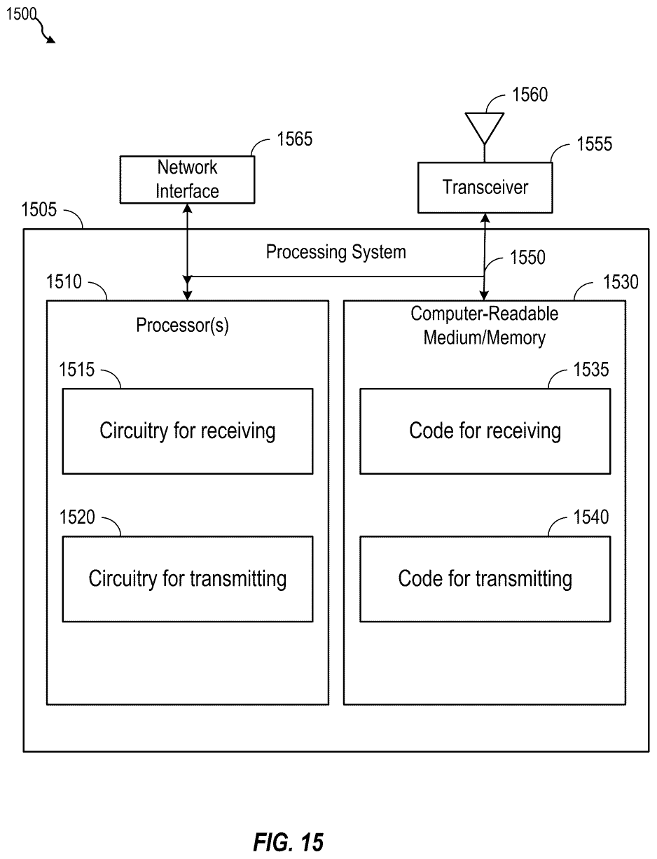

Method 1300 begins at 1310 with receiving capability information of a UE indicating at least one of: one or more features supported by the UE or a list of one or more network entity vendors with which the one or more features have been tested via one or more tests. In some cases, the operations of this step refer to, or may be performed by, circuitry for receiving and/or code for receiving as described with reference to FIG. 15.

Method 1300 then proceeds to 1320 with transmitting a configuration for features based on the capability information of the UE. In some cases, the operations of this step refer to, or may be performed by, circuitry for transmitting and/or code for transmitting as described with reference to FIG. 15.

In certain aspects, the one or more tests include an IODT.

In certain aspects, the capability information indicates, for each feature supported by the UE, a name or an ID of each network entity vendor with which the each feature has been tested.

In certain aspects, the capability information indicates, for each feature supported by the UE, a hash value of a string corresponding to each network entity vendor with which the each feature has been tested; the string includes a sequence of characters; and the string is decided via pre-communication between a vendor of the UE and each network entity vendor.

In certain aspects, the capability information indicates, for each feature supported by the UE, a code value corresponding to each network entity vendor with which the each feature has been tested.

In certain aspects, the capability information indicates, for each feature supported by the UE, a private enterprise number corresponding to each network entity vendor with which the each feature has been tested.

In certain aspects, the capability information indicates, for each feature supported by the UE, a bit value corresponding to each network entity vendor with which the each feature has been tested, and wherein different bit values are mapped to different network entity vendors based on an input from an operator of a subscriber identity module (SIM) card for the UE.

In certain aspects, information associated with the one or more features supported by the UE for each network entity vendor is carried in an encrypted manner in a container corresponding to the network entity vendor.

In one aspect, the method 1300, or any aspect related to it, may be performed by an apparatus, such as a wireless node 1500 of FIG. 15, which includes various components operable, configured, or adapted to perform the method 1300. The wireless node 1400 is described below in further detail.

Note that FIG. 13 is just one example of a method, and other methods including fewer, additional, or alternative steps are possible consistent with this disclosure.

### Example Wireless Nodes

FIG. 14 depicts aspects of an example wireless node (or communications device) 1400. The wireless node 1400 may be a user equipment (UE), such as the UE 104 described above with respect to FIG. 1 and FIG. 3.

The wireless node 1400 includes a processing system 1405 coupled to a transceiver 1445 (e.g., a transmitter and/or a receiver). The transceiver 1445 is configured to transmit and receive signals for the wireless node 1400 via an antenna 1450, such as the various signals as described herein. The processing system 1405 may be configured to perform processing functions for the wireless node 1400, including processing signals received and/or to be transmitted by the wireless node 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1200 described with respect to FIG. 12, and/or any aspect related to it. Note that reference to a processor performing a function of the wireless node 1400 may include the one or more processors 1410 performing that function of the wireless node 1400.

In the depicted example, computer-readable medium/memory 1425 stores code (e.g., executable instructions), such as code for transmitting 1430 and code for receiving 1435. Processing of the code for transmitting 1430 and the code for receiving 1435 may cause the wireless node 1400 to perform the method 1200 described with respect to FIG. 12, and/or any aspect related to it.

The one or more processors 1410 include circuitry configured to implement (e.g., execute) the code stored in the computer-readable medium/memory 1425, including circuitry such as circuitry for transmitting 1415 and circuitry for receiving 1420. Processing with the circuitry for transmitting 1415 and the circuitry for receiving 1420 may cause the wireless node 1400 to perform the method 1200 described with respect to FIG. 12, and/or any aspect related to it.

Various components of the wireless node 1400 may provide means for performing the method 1200 described with respect to FIG. 12, and/or any aspect related to it. For example, means for transmitting, sending or outputting (e.g., for transmission) may include transceivers 354 and/or antenna(s) 352 of the UE 104 illustrated in FIG. 3 and/or the code for transmitting 1430, the circuitry for transmitting 1415, the transceiver 1445 and the antenna 1450 of the wireless node 1400 in FIG. 14. Means for receiving or obtaining may include transceivers 354 and/or antenna(s) 352 of the UE 104 illustrated in FIG. 3 and/or the code for receiving 1435, the circuitry for receiving 1420, the transceiver 1445 and the antenna 1450 of the wireless node 1400 in FIG. 14.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive multiple-input and multiple-output (MIMO) processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 14 is an example, and many other examples and configurations of the wireless node 1400 are possible.

FIG. 15 depicts aspects of an example wireless node (or communications device) 1500. The wireless node 1500 may be a network entity, such as the 5GC 190 of FIG. 1, or the BS 102 of FIG. 1 and FIG. 3.

The wireless node 1500 includes a processing system 1505 coupled to a transceiver 1555 (e.g., a transmitter and/or a receiver) and/or a network interface 1565. The transceiver 1555 is configured to transmit and receive signals for the wireless node 1500 via an antenna 1560, such as the various signals as described herein. The network interface 1565 is configured to obtain and send signals for the wireless node 1500 via communication link(s), such as a backhaul link, midhaul link, and/or fronthaul link as described herein, such as with respect to FIG. 2. The processing system 1505 may be configured to perform processing functions for the wireless node 1500, including processing signals received and/or to be transmitted by the wireless node 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1300 described with respect to FIG. 13, or any aspect related to it. Note that reference to a processor of the wireless node 1500 performing a function may include the one or more processors 1510 of the wireless node 1500 performing that function.

In the depicted example, the computer-readable medium/memory 1530 stores code (e.g., executable instructions), such as code for receiving (or obtaining) 1535 and code for transmitting (or outputting) 1540. Processing of the code for receiving 1535 and the code for transmitting 1540 may cause the wireless node 1500 to perform the method 1300 described with respect to FIG. 13, or any aspect related to it.

The one or more processors 1510 include circuitry configured to implement (e.g., execute) the code stored in the computer-readable medium/memory 1530, including circuitry such as circuitry for receiving (or obtaining) 1515 and circuitry for transmitting (or outputting) 1520. Processing with the circuitry for receiving 1515 and the circuitry for transmitting 1520 may cause the wireless node 1500 to perform the method 1300 described with respect to FIG. 13, or any aspect related to it.

Various components of the wireless node 1500 may provide means for performing the method 1300 described with respect to FIG. 13, or any aspect related to it. Means for transmitting, sending or outputting for transmission may include transceivers 332 and/or antenna(s) 334 of the BS 102 illustrated in FIG. 3 and/or the circuitry for transmitting 1520, the code for transmitting 1540, the transceiver 1555 and the antenna 1560 of the wireless node 1500 in FIG. 15. Means for receiving or obtaining may include transceivers 332 and/or antenna(s) 334 of the BS 102 illustrated in FIG. 3 and/or the circuitry for receiving 1515, the code for receiving 1535, the transceiver 1555 and the antenna 1560 of the wireless node 1500 in FIG. 15.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 15 is an example, and many other examples and configurations of the wireless node 1500 are possible.

### Example Clauses

Implementation examples are described in the following numbered clauses:
Clause 1: A method for wireless communications at a user equipment (UE), including: transmitting capability information indicating at least one of: one or more features supported by the UE or a list of one or more network entity vendors with which the one or more features have been tested via one or more tests; and receiving a configuration for features based on the capability information.
Clause 2: The method of clause 1, wherein the one or more tests include an interoperability device testing (IODT).
Clause 3: The method of any one of clauses 1-2, wherein the capability information indicates, for each feature supported by the UE, a name or an identifier (ID) of each network entity vendor with which the each feature has been tested.
Clause 4: The method of any one of clauses 1-3, wherein: the capability information indicates, for each feature supported by the UE, a hash value of a string corresponding to each network entity vendor with which the each feature has been tested; the string includes a sequence of characters; and the string is decided via pre-communication between a vendor of the UE and each network entity vendor.
Clause 5: The method of any one of clauses 1-4, wherein the capability information indicates, for each feature supported by the UE, a code value corresponding to each network entity vendor with which the each feature has been tested.
Clause 6: The method of any one of clauses 1-5, wherein the capability information indicates, for each feature supported by the UE, a private enterprise number corresponding to each network entity vendor with which the each feature has been tested.
Clause 7: The method of any one of clauses 1-6, wherein the capability information indicates, for each feature supported by the UE, a bit value corresponding to each network entity vendor with which the each feature has been tested, and wherein different bit values are mapped to different network entity vendors based on an input from an operator of a subscriber identity module (SIM) card for the UE.
Clause 8: The method of any one of clauses 1-7, wherein information associated with the one or more features supported by the UE for each network entity vendor is carried in an encrypted manner in a container corresponding to the network entity vendor.
Clause 9: The method of clause 7, further including: receiving signaling carrying a table including a mapping of the different bit values to the different network entity vendors; and using the table to generate the capability information including the list of the one or more network entity vendors with which the one or more features have been tested.
Clause 10: The method of any one of clauses 1-9, further including: establishing a connection with a first network entity; transmitting, to an access and mobility management function (AMF) based on the connection with the first network entity, a registration or a service request; and receiving, from the AMF in response to the registration or the service request, a response message including information corresponding to a vendor of the first network entity.
Clause 11: The method of clause 10, wherein the information corresponding to the vendor of the first network entity is received via at least one of: non-access stratum (NAS) signaling or multicast broadcast services (MBS).
Clause 12: The method of clause 10, further including: determining whether the one or more features supported by the UE that are stated in the capability information have been tested for the vendor of the first network entity; and updating the capability information in accordance with the determination.
Clause 13: The method of clause 12, wherein updating the capability information includes updating the capability information to indicate that the one or more features are not supported by the UE when the one or more features have not been tested for the vendor of the first network entity.
Clause 14: The method of any one of clauses 1-13, further including: moving from a connection with a first network entity associated with a first vendor to a second network entity associated with a second vendor; and receiving, from an access and mobility management function (AMF), information corresponding to the second vendor of the second network entity.
Clause 15: The method of clause 14, wherein: the capability information is advertised based on the connection with the first network entity associated with the first vendor; and the one or more features supported by the UE that are stated in the capability information have been tested for at least the first vendor of the first network entity.
Clause 16: The method of clause 14, further including: determining whether the one or more features supported by the UE that are stated in the capability information have been tested for the second vendor of the second network entity; and updating the capability information in accordance with the determination.
Clause 17: The method of clause 16, wherein updating the capability information includes updating the capability information to indicate that the one or more features are not supported by the UE when the one or more features have not been tested for the second vendor of the second network entity.
Clause 18: A method for wireless communications at a network entity, including: receiving capability information of a user equipment (UE) indicating at least one of: one or more features supported by the UE or a list of one or more network entity vendors with which the one or more features have been tested via one or more tests; and transmitting a configuration for features based on the capability information of the UE.
Clause 19: The method of clause 18, wherein the one or more tests include an interoperability device testing (IODT).
Clause 20: The method of any one of clauses 18-19, wherein the capability information indicates, for each feature supported by the UE, a name or an identifier (ID) of each network entity vendor with which the each feature has been tested.
Clause 21: The method of any one of clauses 18-20, wherein: the capability information indicates, for each feature supported by the UE, a hash value of a string corresponding to each network entity vendor with which the each feature has been tested; the string includes a sequence of characters; and the string is decided via pre-communication between a vendor of the UE and each network entity vendor.
Clause 22: The method of any one of clauses 18-21, wherein the capability information indicates, for each feature supported by the UE, a code value corresponding to each network entity vendor with which the each feature has been tested.
Clause 23: The method of any one of clauses 18-22, wherein the capability information indicates, for each feature supported by the UE, a private enterprise number corresponding to each network entity vendor with which the each feature has been tested.
Clause 24: The method of any one of clauses 18-23, wherein the capability information indicates, for each feature supported by the UE, a bit value corresponding to each network entity vendor with which the each feature has been tested, and wherein different bit values are mapped to different network entity vendors based on an input from an operator of a subscriber identity module (SIM) card for the UE.
Clause 25: The method of any one of clauses 18-24, wherein information associated with the one or more features supported by the UE for each network entity vendor is carried in an encrypted manner in a container corresponding to the network entity vendor.
Clause 26: An apparatus, including: at least one memory including instructions; and one or more processors configured, individually or in any combination, to execute the instructions and cause the apparatus to perform a method in accordance with any one of Clauses 1-25.
Clause 27: An apparatus, including means for performing a method in accordance with any one of Clauses 1-25.
Clause 28: A non-transitory computer-readable medium including executable instructions that, when executed by one or more processors of an apparatus, cause the apparatus to perform a method in accordance with any one of Clauses 1-25.
Clause 29: A computer program product embodied on a computer-readable storage medium including code for performing a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
transmit capability information indicating at least one of: one or more features supported by the UE or a list of one or more network entity vendors with which the one or more features have been tested via one or more tests; and
receive a configuration for features based on the capability information.

2. The apparatus of claim 1, wherein the one or more tests comprise an interoperability device testing (IODT).

3. The apparatus of claim 1, wherein the capability information indicates, for each feature supported by the UE, a name or an identifier (ID) of each network entity vendor with which the each feature has been tested.

4. The apparatus of claim 1, wherein
the capability information indicates, for each feature supported by the UE, a hash value of a string corresponding to each network entity vendor with which the each feature has been tested;
the string comprises a sequence of characters; and
the string is decided via pre-communication between a vendor of the UE and each network entity vendor.

5. The apparatus of claim 1, wherein the capability information indicates, for each feature supported by the UE, a code value corresponding to each network entity vendor with which the each feature has been tested.

6. The apparatus of claim 1, wherein the capability information indicates, for each feature supported by the UE, a private enterprise number corresponding to each network entity vendor with which the each feature has been tested.

7. The apparatus of claim 1, wherein the capability information indicates, for each feature supported by the UE, a bit value corresponding to each network entity vendor with which the each feature has been tested, and wherein different bit values are mapped to different network entity vendors based on an input from an operator of a subscriber identity module (SIM) card for the UE.

8. The apparatus of claim 1, wherein information associated with the one or more features supported by the UE for each network entity vendor is carried in an encrypted manner in a container corresponding to the network entity vendor.

9. The apparatus of claim 7, wherein the one or more processors, individually or collectively, are configured to execute the instructions and cause the apparatus to:
receive signaling carrying a table comprising a mapping of the different bit values to the different network entity vendors; and
use the table to generate the capability information including the list of the one or more network entity vendors with which the one or more features have been tested.

10. The apparatus of claim 1, wherein the one or more processors, individually or collectively, are configured to execute the instructions and cause the apparatus to:
establish a connection with a first network entity;
transmit, to an access and mobility management function (AMF) based on the connection with the first network entity, a registration or a service request; and
receive, from the AMF in response to the registration or the service request, a response message comprising information corresponding to a vendor of the first network entity.

11. The apparatus of claim 10, wherein the information corresponding to the vendor of the first network entity is received via at least one of: non-access stratum (NAS) signaling or multicast broadcast services (MBS).

12. The apparatus of claim 10, wherein the one or more processors, individually or collectively, are configured to execute the instructions and cause the apparatus to:
determine whether the one or more features supported by the UE that are stated in the capability information have been tested for the vendor of the first network entity; and
update the capability information in accordance with the determination.

13. The apparatus of claim 12, wherein the one or more processors, individually or collectively, are configured to execute the instructions and cause the apparatus to:
update the capability information to indicate that the one or more features are not supported by the UE when the one or more features have not been tested for the vendor of the first network entity.

14. The apparatus of claim 1, wherein the one or more processors, individually or collectively, are configured to execute the instructions and cause the apparatus to:
move from a connection with a first network entity associated with a first vendor to a second network entity associated with a second vendor; and
receive, from an access and mobility management function (AMF), information corresponding to the second vendor of the second network entity.

15. The apparatus of claim 14, wherein:
the capability information is advertised based on the connection with the first network entity associated with the first vendor; and
the one or more features supported by the UE that are stated in the capability information have been tested for at least the first vendor of the first network entity.

16. The apparatus of claim 14, wherein the one or more processors, individually or collectively, are configured to execute the instructions and cause the apparatus to:
determine whether the one or more features supported by the UE that are stated in the capability information have been tested for the second vendor of the second network entity; and
update the capability information in accordance with the determination.

17. The apparatus of claim 16, wherein the one or more processors, individually or collectively, are configured to execute the instructions and cause the apparatus to:
update the capability information to indicate that the one or more features are not supported by the UE when the one or more features have not been tested for the second vendor of the second network entity.

18. A method for wireless communications at a user equipment (UE), comprising:
transmitting capability information indicating at least one of: one or more features supported by the UE or a list of one or more network entity vendors with which the one or more features have been tested via one or more tests; and
receiving a configuration for features based on the capability information.

19. The method of claim 18, wherein the one or more tests comprise an interoperability device testing (IODT).

20. A non-transitory computer-readable medium comprising instructions that, when executed by one or more processors of a user equipment (UE), cause the one or more processors to perform a method, comprising:
transmitting capability information indicating at least one of: one or more features supported by the UE or a list of one or more network entity vendors with which the one or more features have been tested via one or more tests; and
receiving a configuration for features based on the capability information.
